(19) United States
(12) Patent Application Publication
(10) Pub. No.: US 2017/0066680 A1
(43) Pub. Date: Mar. 9, 2017

(54) LASER DRILLING APPARATUS AND LASER DRILLING METHOD OF TEMPERED GLASS

(71) Applicant: Industrial Technology Research Institute, Hsinchu (TW)

(72) Inventors: Chun-Jen Gu, Taipei City (TW); Yu-Chung Lin, Tainan City (TW); Mao-Chi Lin, Tainan City (TW); Chun-Ming Chen, Tainan City (TW)

(21) Appl. No.: 14/968,902

(22) Filed: Dec. 15, 2015

(30) Foreign Application Priority Data
Sep. 8, 2015 (TW) 104129600

(51) Int. Cl. C03B 33/10

(52) U.S. Cl. CPC C03B 33/102

(57) ABSTRACT

In an embodiment, a laser drilling apparatus adapted to a tempered glass includes a laser source, a drilling unit, a gas supply source, a heater and an air supplier. The laser source provides a laser beam. The drilling unit has a zoom lens set and a laser scanner unit. The laser beam passes through the zoom lens set and the laser scanner unit. The gas supply source supplies an air flow. The heater is disposed on a flow channel of the air flow and heats up the air flow. The air supplier has a nozzle. Both the laser beam and the heated-up air flow reach an area to be machined of the tempered glass through the nozzle. In an embodiment, a laser drilling method for the tempered glass is also provided.

### CROSS-REFERENCE TO RELATED APPLICATION

This application claims the priority benefit of Taiwan application serial no. 104129600, filed on Sep. 8, 2015. The entirety of the above-mentioned patent application is hereby incorporated by reference herein and made a part of this specification.

### TECHNICAL FIELD

The technical field relates to a laser drilling apparatus adapted to a tempered glass and a laser drilling method for the tempered glass.

### BACKGROUND

The drilling technologies for a glass use cutting tools to proceed a mechanical drilling process. With the quickly development of industry, the thickness of the glass in product is tending to thinning, and the request of the strength of the glass is higher and higher. Thus, it becomes popular to use a tempered glass in all kinds of products. When the cutting tools are used to proceed the mechanical drilling process, the damages or destroy of the cutting tools may be over severe. A laser drilling process is a non-contacting drilling process without damage problem of the cutting tools; therefore, the laser drilling process is gradually applied to the tempered glass.

During the laser drilling process, there is amassed debris in the hole to decrease the efficiency of the drilling. To solve the problem of the amassed debris, one of solutions is side-blown from the side of the working area to the hole by using the air flow to clean up the debris. However, when the depth of the drilling gets deeper, it is more difficult to clean up the debris at the bottom of the hole.

### SUMMARY

According to an embodiment of the disclosure, a laser drilling apparatus is adapted to a tempered glass. The laser drilling apparatus comprises a laser source, a drilling unit, a gas supply source, a heater and an air supplier. The laser source provides a laser beam. The drilling unit has a zoom lens set and a laser scanner unit. The laser beam passes through the zoom lens set and the laser scanner unit. The gas supply source supplies an air flow. The heater is disposed on a flow channel of the air flow and heats up the air flow. The air supplier has a nozzle. Both the air flow heated up and the laser beam reach an area to be machined of the tempered glass via the nozzle.

According to another embodiment of the disclosure, a laser drilling method for a tempered glass comprises: providing a laser beam and an air flow on the same location of a tempered glass to perform a laser drilling process; and moving a focal point of the laser beam by a three-dimensional way of surrounding several circles, and heating the tempered glass via the air flow heated up.

The foregoing will become better understood from a careful reading of a detailed description provided herein below with appropriate reference to the accompanying drawings.

### BRIEF DESCRIPTION OF THE DRAWINGS

FIG. 1 is a schematic view of a laser drilling apparatus according to an embodiment of the disclosure.

FIG. 2 is a schematic view of a gradient variation of the temperature on the tempered glass after being heated by the air flow.

FIG. 3A and FIG. 3B are schematic views of a relative motion of the laser beam and the tempered glass in the laser drilling method for the tempered glass according to two embodiments of the disclosure, respectively.

### DETAILED DESCRIPTION OF DISCLOSED EMBODIMENTS

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

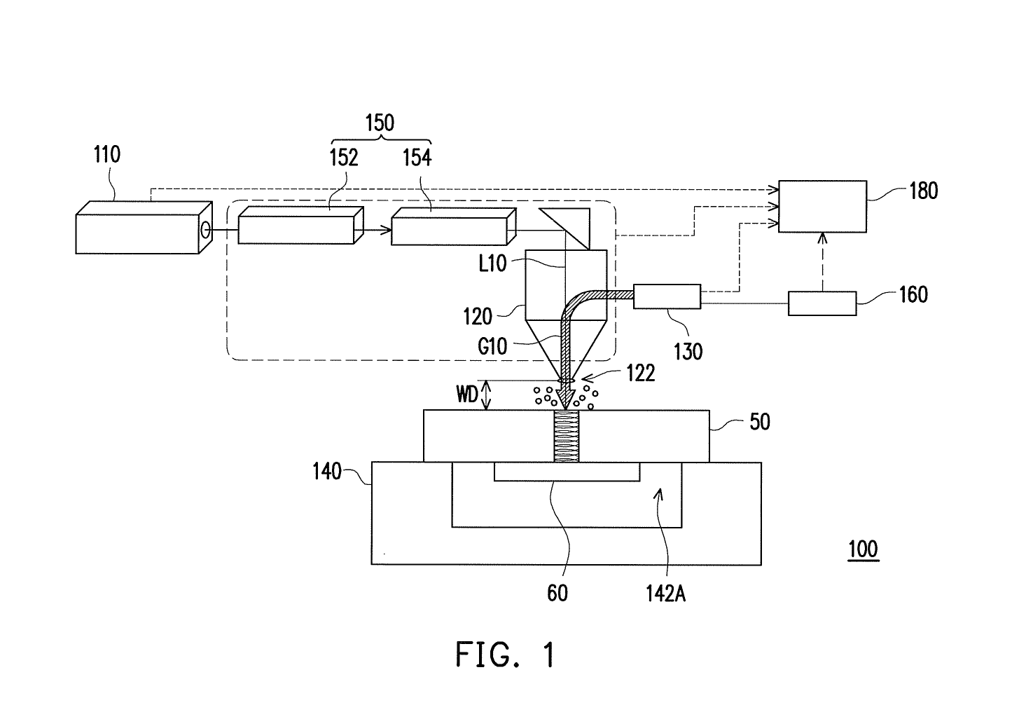

FIG. 1 is a schematic view of a laser drilling apparatus according to an embodiment of the disclosure. Referring to FIG. 1, a laser drilling apparatus 100 is adapted to a tempered glass 50. The laser drilling apparatus 100 comprises a laser source 110, a drilling unit 150, a gas supply source 160, a heater 130 and an air supplier 120. The laser source 110 provides a laser beam L10. The gas supply source 160 supplies an air flow G10. The heater 130 is disposed on a flow channel of the air flow G10 and heats up the air flow G10 before the air flow G10 reaches the tempered glass 50. The air supplier 120 has a nozzle 122. Both the air flow G10 heated up and the laser beam L10 reach an area to be machined of the tempered glass through the nozzle 122. The laser beam L10 drills the tempered glass 50 and the heated-up air flow G10 heats up the tempered glass 50 and cleans up the debris.

In an embodiment of the disclosure, a laser drilling method for a tempered glass may carry out by using the laser drilling apparatus 100, but the scope of the disclosure t is not limited thereto. In this embodiment, the laser drilling method for the tempered glass includes offering a laser beam L10 and a heated-up air flow G10 through the nozzle 122 of the air supplier 120 at the same time. Both of the laser beam L10 and the heated-up air flow G10 pass through the nozzle 122 and reach the tempered glass 50. The laser beam L10 drills the tempered glass 50 and the heated-up air flow G10 heats up the tempered glass 50 and cleans up the debris.

As aforementioned, both of the laser beam L10 and the heated-up air flow G10 reach an area to be machined of the tempered glass 50 through the nozzle 122, so the debris produced after drilling the tempered glass 50 by the laser beam L10 may actually be taken away from the air flow G10. This solves the problem of existing a dead space and incapable of cleaning the debris by the side-blown air flow in the conventional technology. Thus, the quality and the velocity of the drill is good and fast by using the laser drilling apparatus and the laser drilling method for a tempered glass in the embodiment of the disclosure.

In order to reach a good effect of discharging debris, and avoid too much gas pressure damaging the tempered glass 50, the air flow G10 may provide the tempered glass 50 with a fixed amount and a fixed temperature. The flow rate of the air flow G10 may have a range from 30 L/mm to 800 L/mm. The pressure of the air flow G10 may have a range from 1 bar to 30 bar. The laser source 110 may be an ultraviolet (UV) laser source, a green semiconductor laser source, a near-infrared (NIR) light source, or other laser sources. The scope of the disclosure is not limited thereto.

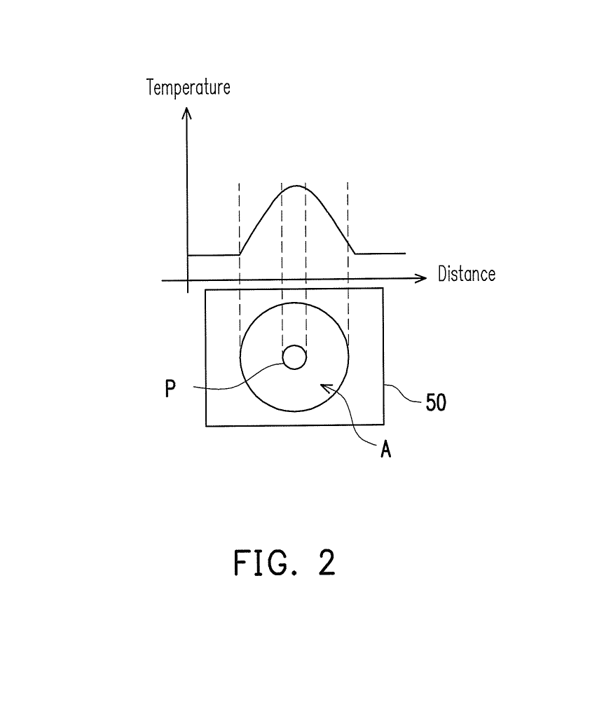

The air supplier 120 is a co-axis air supplier. The laser beam L10 and the heated air flow G10 co-axially pass through the nozzle 122. However, as long as both of the laser beam L10 and the heated air flow G10 pass through the nozzle 122, it is not necessary that the laser beam L10 and the heated air flow G10 are co-axial. Basically, both the laser beam L10 and the heated air flow G10 offered to the tempered glass 50 pass through the nozzle 122 along a same axis. Thus, the heating effect of the air flow G10 to the tempered glass 50 may extend from the focal point P of the laser beam L10 to outward. Because the heated-up air flow G10 heats up the tempered glass 50, it is not only a high temperature in the partial area of the tempered glass 50 where the laser beam L10 irradiated, but also a large area of the tempered glass 50 is heated up and has a gradual variation of the temperature gradient, as shown in FIG. 2. After improving the situation of the abrupt variation of the temperature gradient in the conventional technology, it may prevent the tempered glass 50 from splitting during the drilling process. Thus, the subsequent machining processes may prevent the tempered glass 50 from growing the rift or even being split off In the embodiment of the disclosure, a diameter of the speckle formed on the tempered glass 50 by a focal point P of the laser beam L10 is less than 20 μm. A diameter of an area A on the tempered glass 50 heated by the air flow G10 has a range from 1 mm to 20 mm. The temperature heated by the air flow G10 has a range from 80° C. to 500° C.

Please refer to FIG. 1. At the bottom of the area to be machined of the tempered glass 50 may further dispose a sacrificed layer 60. The sacrificed layer 60 transforms parts of the laser beam L10 transmitting to the bottom of the tempered glass 50 into a thermal energy. The thermal energy is transmitted to the tempered glass 50 by a heat conduction, and the tempered glass 50 is heated up. Thus, it assists the tempered glass 50 to have a gradual variation of the temperature gradient and improves the split situation of the tempered glass 50 during the machining process. In the embodiment of the disclosure, the sacrificed layer 60 covers the whole speckle formed on the tempered glass 50 by the laser beam L10. The sacrificed layer 60 may be an ink layer, a polymer thin film, or other material layers. The thickness of the sacrificed layer 60 has a range from 50 μm to 500 μm. In addition, the sacrificed layer 60 is disposed at the bottom of the tempered glass 50 in this embodiment. In an embodiment, the sacrificed layer 60 may be disposed on the top surface of the area to be machined of the tempered glass 50. After the laser drilling process is finished, the sacrificed layer 60 may be removed.

Please refer back to FIG. 1. The laser drilling apparatus 100 further includes a supporting table 140. The supporting table 140 may support the tempered glass 50. The supporting table 140 has a hollow area 142A. When the tempered glass 50 is disposed on the supporting table 140, the area to be machined of the tempered glass 50 is situated on the hollow area 142A. In other words, the hollow area 142A is smaller than the tempered glass 50. The hollow area 142A may provide a space to discharge the debris during the laser drilling process.

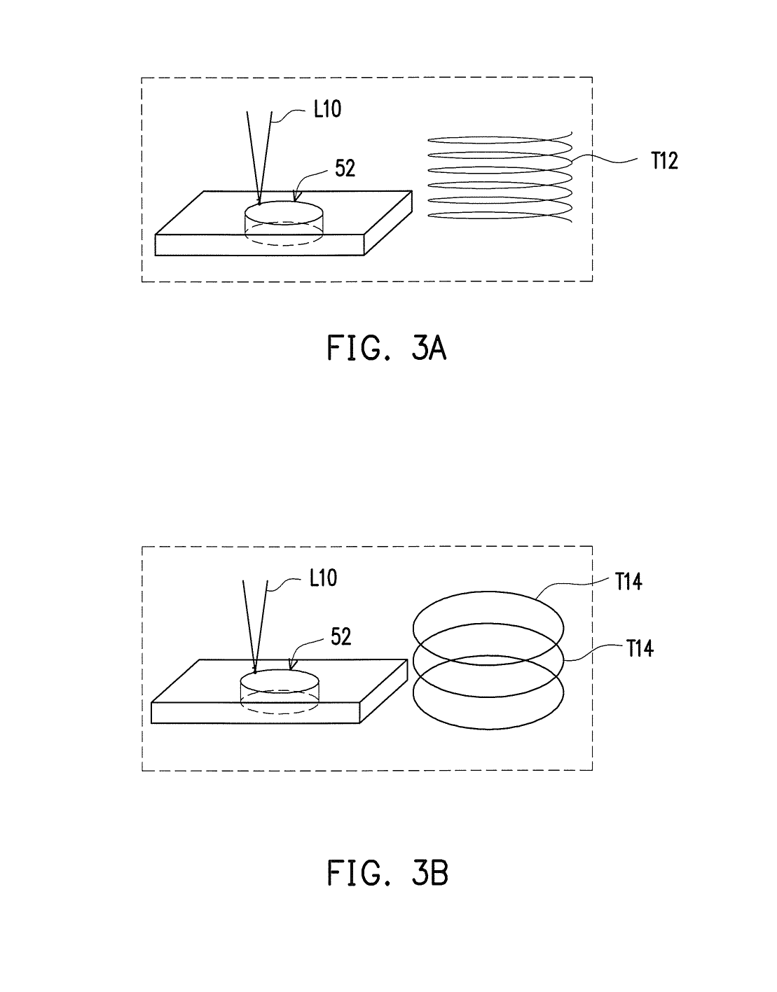

The pressure and the temperature applied on the tempered glass 50 by the air flow G10 may vary. Therefore, in the embodiment of the disclosure, a working distance WD between the nozzle 122 and the surface of the tempered glass 50 may keep stable such as 3 mm during the drilling process. While the focal point P of the laser beam L10 requires to move down from the surface of the tempered glass 50. FIG. 3A and FIG. 3B are schematic views of a relative motion of the laser beam and the tempered glass in the laser drilling method for the tempered glass according to two embodiments of the disclosure, respectively. Please refer to FIG. 1 and FIG. 3A. Generally, the drilling 52 to be formed in the tempered glass 50 is much greater than the speckle formed on the tempered glass 50 by the laser beam L10. During the laser drilling process, the focal point P of the laser beam L10 moves by a three-dimensional way of surrounding several circles along the edges of the drilling 52, and the laser beam L10 etches on the tempered glass 50. At last, a part in the drilling 52 of the tempered glass 50 is separated from an un-machined part of the tempered glass 50. Thus, the drilling unit 150 has a zoom lens set 152 and a laser scanner unit 154. The zoom lens set 152 may change a focal distance of the laser beam L10 to have an optical zoom and an adjustable depth of field function. The laser scanner unit 154 may deflect the laser beam L10 to a required location rapidly. By the arrangement of the zoom lens set 152 and the laser scanner unit 154 of the drilling unit 150, the laser beam L10 passes through the zoom lens set 152 and the laser scanner unit 154, and then the laser beam L10 may enforce a dynamic longitudinal position quickly zoom to the movement of the circular trace of the laser beam. The laser scanner unit 154 may be a trepan optical module, a galvanometer scanning module, or other types of optical modules. By using the drilling unit 150, the position contacting the tempered glass 50 that the laser beam L10 and the heated air flow G10 passed through the nozzle 122 of the air supplier 120 may be moved surrounding circles and along the edges of the drilling 52. At the same time, the focal point P of the laser beam L10 is adjusted to keep going down. Accordingly, the focal point P of the laser beam L10 may follow the trace T12 shown in FIG. 3A to move down spirally from the surface of the tempered glass 50 and finally finish the laser drilling process. Or the position of the focal point P of the laser beam L10 changes after every completely moving surrounding circles along the whole edges of the drilling 52 once or several times. The focal point P of the laser beam L10 keeps on the same plane when the laser beam L10 moves surrounding circles. As a result, the focal point P of the laser beam L10 follows the trace T14 to move surrounding circles several times at the same depth from the surface of the tempered glass 50, respectively, and moved down to one of the several circles every time in an order of from a highest circle to a lowest circle, and finally the laser drilling process is finished as shown in FIG. 3B. By following the two types of the traces shown in FIGS. 3A and 3B, it is helpful to decrease the cone error of the drilling 52.

Because the focal point P of the laser beam L10 has different traces to move in company with the laser drilling process, the depth of field of the heated-up air flow G10 needs to design in collocation with the optical zoom of the laser beam L10. In detail, when the heated-up air flow G10 passes through the air supplier 120 and jets out of the nozzle 122, the depth of field of the heated-up air flow G10 may cover the zoom range of the laser beam L10 zoomed by the drilling unit 150. Therefore, when the laser beam L10 is zoomed due to drilling, the air supplier 120 still supplies the air flow G10 sufficient to cover the speckle of the laser beam L10 to the tempered glass 50 machined by the laser beam L10. The laser beam L10 and the heated air flow G10 is co-axially supplied to the tempered glass 50.

In the embodiment of the disclosure, when the heated air flow G10 heats the tempered glass 50 as shown in FIG. 1, the heated area of the tempered glass 50 covers the whole drilling 52 formed as the embodiments of FIG. 3A or FIG. 3B. In addition, the laser drilling apparatus 100 may further include a control unit 180 that controls and couples to the laser source 110, the air supplier 120, the heater 130, the drilling unit 150, and the gas supply source 160. For example, the control unit 180 may control the energy of the laser beam L10 sent from the laser source 110 and coordinate the gas supply source 160, the heater 130, and the drilling unit 150 to heat and drill synchronously.

In the embodiments of the laser drilling apparatus and a laser drilling method for a tempered glass of the disclosure, the laser beam and the air flow substantially co-axially pass through the same nozzle and reach the tempered glass to be machined. Therefore, the air flow may substantially clean up the debris produced during the laser drilling process and increase the quality and the speed of the drill. Moreover, by using the heated-up air flow and/or including the sacrificed layer during the laser drilling process of heating the large area of the tempered glass, the variation of the temperature gradient may be mitigated after the tempered glass is heated. It may decrease the production of the rift and prevent the tempered glass from splitting by the subsequent machining processes.

It will be apparent to those skilled in the art that various modifications and variations can be made to the disclosed embodiments. It is intended that the specification and examples be considered as exemplars only, with a true scape of the disclosure being indicated by the following claims and their equivalents.

What is claimed is:

1. A laser drilling apparatus, adapted to a tempered glass, the laser drilling apparatus comprising:
a laser source, providing a laser beam;
a drilling unit, having a zoom lens set and a laser scanner unit, wherein the laser beam passes through the zoom lens set and the laser scanner unit;
a gas supply source, supplying an air flow;
a heater, disposed on a flow channel of the air flow and configured to heat the air flow; and
an air supplier, having a nozzle;
wherein both the air flow heated up and the laser beam reach an area to be machined of the tempered glass through the nozzle.

2. The laser drilling apparatus as claimed in claim 1, wherein the air supplier is a co-axis air supplier, and the laser beam and the heated air flow heated up co-axially pass through the nozzle.

3. The laser drilling apparatus as claimed in claim 1, further including:
a sacrificed layer, disposed on the tempered glass, wherein the sacrificed layer transforms the laser beam into a thermal energy and the thermal energy heats up the tempered glass.

4. The laser drilling apparatus as claimed in claim 3, wherein the sacrificed layer is an ink layer or a polymer thin film.

5. The laser drilling apparatus as claimed in claim 3, wherein a thickness of the sacrificed layer has a range from 50 μm to 500 μm.

6. The laser drilling apparatus as claimed in claim 1, wherein the laser source is an ultraviolet laser source, a green semiconductor laser source, or a near-infrared light source.

7. A laser drilling method for a tempered glass, comprising:
providing a laser beam and an air flow on a same location of a tempered glass to perform a laser drilling process; and
moving a focal point of the laser beam by a three-dimensional way of surrounding several circles, and heating the tempered glass via the air flow heated up.

8. The laser drilling method as claimed in claim 7, wherein during the laser drilling process is performed for the tempered glass, the focal point of the laser beam is moved down spirally from a surface of the tempered glass.

9. The laser drilling method as claimed in claim 7, wherein during the laser drilling process is performed for the tempered glass, the focal point of the laser beam is moved surrounding the several circles several times at a same depth from the surface of the tempered glass, respectively, and moved down to one of the several circles every time in an order of from a highest circle to a lowest circle.

10. The laser drilling method as claimed in claim 7, wherein the air flow is provided to the tempered glass with a fixed amount and a fixed temperature.

11. The laser drilling method as claimed in claim 7, wherein a temperature heating up the air flow has a range from 80° C. to 500° C.

12. The laser drilling method as claimed in claim 7, wherein a flow rate of the air flow has a range from 30 L/mm to 800 L/mm.

13. The laser drilling method as claimed in claim 7, wherein a pressure of the air flow has a range from 1 bar to 30 bar.

14. The laser drilling method as claimed in claim 7, wherein the laser beam and the air flow are co-axially provided to the tempered glass.

15. The laser drilling method as claimed in claim 7, wherein a depth of field of the air flow covers a zoom range of the laser beam.

16. The laser drilling method as claimed in claim 7, wherein the laser beam and the air flow heated up is provided to the tempered glass through a nozzle of an air supplier.

17. The laser drilling method as claimed in claim 16, wherein a working distance between the nozzle and the tempered glass keeps stable during the laser drilling process.

18. The laser drilling method as claimed in claim 7, wherein a diameter of an area on the tempered glass heated by the air flow has a range from 1 mm to 20 mm.

19. The laser drilling method as claimed in claim 7, wherein the laser beam is transformed into a thermal energy to heat up the tempered glass by a sacrificed layer disposed on the tempered glass.

20. The laser drilling method as claimed in claim 19, wherein an area of the sacrificed layer covers a whole drilling formed on the tempered glass.

21. The laser drilling method as claimed in claim 19, wherein a thickness of the sacrificed layer has a range from 50 μm to 500 μm.
